(19) United States
(12) Patent Application Publication
(10) Pub. No.: US 2026/0311298 A1
(43) Pub. Date: Oct. 8, 2026

(54) INFORMATION PROCESSING METHOD, APPARATUS, TERMINAL AND STORAGE MEDIUM

(71) Applicant: Beijing Zitiao Network Technology Co., Ltd., Beijing (CN)

(72) Inventors: Zaishang WANG, Beijing (CN); Bingtian HAN, Beijing (CN)

(21) Appl. No.: 19/482,141

(22) PCT Filed: Apr. 26, 2024
(86) PCT No.: PCT/CN2024/090112

§ 371 Date: Nov. 6, 2025

(30) Foreign Application Priority Data
May 6, 2023 (CN) 202310506059.7

(51) Int. Cl. G06T 5/50; G02B 27/01

(52) U.S. Cl. CPC G06T 5/50; G02B 27/017; G06T 2207/20221

(57) ABSTRACT

The present disclosure provides an information processing method and apparatus, a terminal, and a storage medium. The information processing method includes: displaying an information input page in a first image displayed in a screen interface of a head-mounted device in response to a preset operation; obtaining a second image through a camera; displaying the second image in the screen interface; and inputting target information in the information input page based on information in the second image.

### CROSS REFERENCE TO RELATED APPLICATIONS

The present application is based on and claims priority to Chinese Patent Application No. 202310506059.7, filed on May 6, 2023, which is incorporated herein by reference in its entirety.

### TECHNICAL FIELD

The present disclosure relates to the field of information technology, and in particular, to an information processing method and apparatus, a terminal, and a storage medium.

### BACKGROUND

At present, inputting through a head-mounted device (for example, a virtual reality (VR) headset) is performed by clicking a virtual keyboard with a handle, and generally includes the following steps: entering a screen interface of the head-mounted device; clicking an information input page with the handle; if an external prompt for information to be input (for example, a user name and a password) is involved, adjusting the head-mounted device to view the external prompt; and then inputting the information while viewing the external prompt until the input is completed. Because the head-mounted device is immersive, if external information needs to be acquired for inputting, the user needs to loosen the headset of the head-mounted device to view the external information, and then wear the headset to continue inputting.

### SUMMARY

The present disclosure provides an information processing method and apparatus, a terminal, and a storage medium.

An embodiment of the present disclosure provides an information processing method. The information processing method includes: displaying an information input page in a first image displayed in a screen interface of a head-mounted device in response to a preset operation; obtaining a second image through a camera; displaying the second image in the screen interface; and inputting target information in the information input page based on information in the second image.

Another embodiment of the present disclosure provides an information processing apparatus. The information processing apparatus includes: an input box display module configured to display an information input page in a first image displayed in a screen interface of a head-mounted device in response to a preset operation; an image obtaining module configured to obtain a second image through a camera; an image display module configured to display the second image in the screen interface; and an information input module configured to input target information in the information input page based on information in the second image.

In some embodiments, the present disclosure provides a terminal. The terminal includes: at least one memory and at least one processor, where the memory is configured to store program code, and the processor is configured to invoke the program code stored in the memory to perform the information processing method.

In some embodiments, the present disclosure provides a storage medium. The storage medium is configured to store program code, and the program code is configured to perform the information processing method.

### BRIEF DESCRIPTION OF THE DRAWINGS

The foregoing and other features, advantages, and aspects of embodiments of the present disclosure become more apparent with reference to the following detailed description and in conjunction with the drawings. Throughout the drawings, the same or similar reference numerals refer to the same or similar elements. It should be understood that the drawings are schematic and that elements and components are not necessarily drawn to scale.

FIG. 1 is a flowchart of an information processing method according to an embodiment of the present disclosure.

FIG. 2 is a schematic flowchart of an information processing method according to an embodiment of the present disclosure.

FIG. 3 is some modules of an information processing apparatus according to another embodiment of the present disclosure.

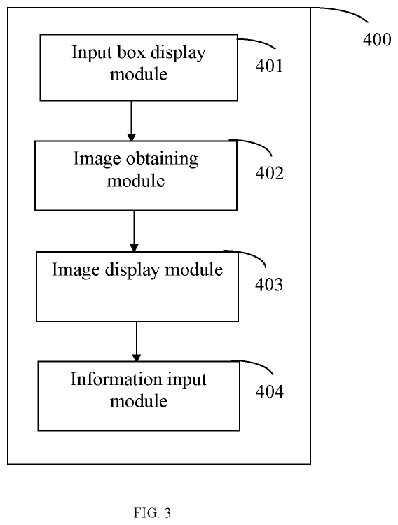

FIG. 4 is a schematic structural diagram of an electronic device according to an embodiment of the present disclosure.

### DETAILED DESCRIPTION

Embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. Rather, these embodiments are provided for a thorough and complete understanding of the present disclosure. It should be understood that the drawings and embodiments of the present disclosure are only for exemplary purposes and are not intended to limit the protection scope of the present disclosure.

It should be understood that various steps described in method implementations of the present disclosure may be performed in sequence and/or in parallel. In addition, the method implementations may include additional steps and/or omit performing the illustrated steps. The scope of the present disclosure is not limited in this aspect.

As used herein, the term “include/comprise” and variations thereof are open-ended inclusions, that is, “include/comprise but not limited to”. The term “based on” is “based, at least in part, on”. The term “an embodiment” represents “at least one embodiment”, the term “another embodiment” represents “at least one another embodiment”, and the term “some embodiments” represents “at least some embodiments”. Related definitions of other terms are given in the following description.

It should be noted that concepts such as “first” and “second” mentioned in the present disclosure are merely intended to distinguish between different apparatuses, modules, or units, and are not intended to limit an order or interdependence of functions performed by these apparatuses, modules, or units.

It should be noted that the modification of “one” mentioned in the present disclosure is schematic and non-restrictive, and those skilled in the art should understand that unless the context clearly indicates otherwise, it should be understood as “one or more”.

The names of messages or information exchanged between a plurality of apparatuses in implementations of the present disclosure are merely for illustrative purposes, and are not intended to limit the scope of these messages or information.

In some related technologies, in a process of using a head-mounted device (for example, a VR headset), a user often exchanges information with the real world when inputting information such as a Wi-Fi user name and a password. However, the head-mounted device is immersive, and therefore the user cannot continuously input information through a handle while acquiring external information, resulting in poor user experience.

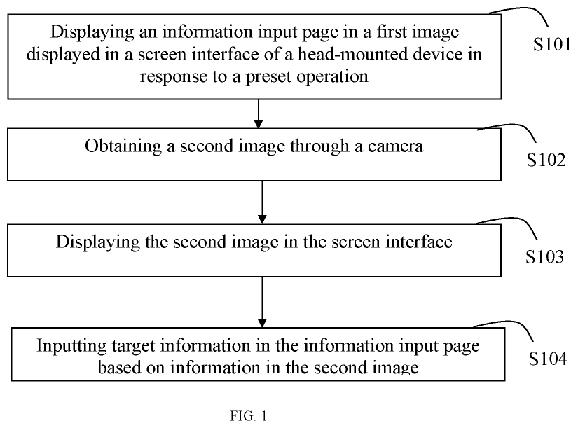

FIG. 1 shows a flowchart of an information processing method according to an embodiment of the present disclosure. The information processing method of the present disclosure may include step S101: displaying an information input page in a first image displayed in a screen interface of a head-mounted device in response to a preset operation. In some embodiments, the preset operation may include any suitable operation that triggers information input, for example, clicking on a control for information input, triggering a control for user name or password input, and the like. In some embodiments, the head-mounted device may include a virtual reality head-mounted device, an extended reality head-mounted device, a mixed reality head-mounted device, and the like. Generally, a virtual reality image or the like may be displayed in the screen interface of the head-mounted device. In some embodiments, the information input page is displayed in the first image displayed in the screen interface of the head-mounted device in response to triggering the control for information input.

In some embodiments, the method of the present disclosure may further include step S102: obtaining a second image through a camera. In some embodiments, in a process of inputting information, information exchange with the real world is often required. For example, when inputting a user name or a password, the user may forget the user name or the password, while the user name and the password may be recorded in a real mobile phone, a real computer, or a real notebook. In the related art, to view the user name and the password for inputting, it may be necessary to loosen a headset and perform corresponding information input after viewing the information, which is inconvenient for the user. In the embodiment of the present disclosure, in a scenario where information input is required, a camera may be determined to provide assistance for information input, that is, the second image including the external information may be obtained through the camera.

In some embodiments, the method of the present disclosure may further include step S103: displaying the second image in the screen interface. In some embodiments, after the second image is obtained, the second image may be displayed in the screen interface. In this way, the user can conveniently view the information in the second image without loosening the headset.

In some embodiments, the method of the present disclosure may further include step S104: inputting target information in the information input page based on information in the second image. In some embodiments, after the second image is displayed, the user can view the information in the second image, and then the input of the target information can be completed in the information input page. For example, the user can view the user name and password information in the displayed second image, and then input the corresponding user name and password information in the information input page.

In the present disclosure, the second image carrying the external information is obtained through the camera, and then the target information is input in the information input page based on the information in the second image. In this way, the user can be assisted in quickly acquiring the required information, and then quickly inputting the information, thereby improving the user experience.

In some embodiments, the method of the present disclosure may further include: determining whether to turn on the camera. In some embodiments, the user may be allowed to determine whether to turn on the camera by means of a prompt control. For example, a prompt control of “whether to turn on the camera” is displayed, and there are two options of “Yes” and “No” for the user to choose. It should be understood that this is only exemplary, and other suitable manners may also be used. In some embodiments, when it is determined to turn on the camera, the second image including the external information may be obtained through the camera. In some embodiments, when it is determined to not turn on the camera, no further processing is performed. In some embodiments, when it is determined to not turn on the camera, it means that the user does not expect to use the information processing method of the present disclosure, and no further processing is needed at this time.

In some embodiments, the camera includes a front camera of the head-mounted device. Generally, the front camera is disposed at a front portion or a front side portion of the head-mounted device, so that a shooting direction and an angle of the camera can be conveniently adjusted by turning the head.

In some embodiments, displaying the second image in the screen interface includes: superimposing and displaying the second image on the first image. For example, the second image is superimposed and displayed on the first image in a form of picture-in-picture. In some embodiments, when the second image is superimposed and displayed on the first image, the second image is not displayed in an area corresponding to the information input page of the first image, so as to avoid blocking the information input page. In some embodiments, the second image is displayed in a display region different from that of the first image in the screen interface, that is, the first image and the second image are displayed in a separate manner and are displayed in different regions of the screen interface, respectively. In this way, the user can simultaneously view the information in the first image and the information in the second image.

In some embodiments, when the second image is superimposed and displayed on the first image, the second image is superimposed and displayed on the first image in a transparent or semi-transparent manner. In this way, interference of the second image with display of information content in the first image can be avoided as much as possible.

In some embodiments, inputting the target information in the information input page based on the information in the second image includes: directly inputting the target information in the information input page through a handle of the head-mounted device. In some embodiments, after the second image is displayed in the screen interface, the user can conveniently view the information in the second image, and then input the target information in the information input page. For example, when user name information needs to be input in the information input page, after viewing the user name information carried in the second image, the user name information is directly input in the information input page through the handle.

In some embodiments, inputting the target information in the information input page based on the information in the second image includes: determining whether the information in the second image is identified; displaying the identified information when it is determined that the information in the second image is identified; and inputting at least part of the identified information in the information input page based on the identified information. In some embodiments, information input may be assisted by identifying the information in the second image, without using an inputting manner such as a virtual keyboard. In some embodiments, whether the information in the second image is identified may be determined by a trigger operation of identifying the information in the second image. In some embodiments, the information in the second image may be identified by optical character recognition (OCR). In some embodiments, a to-be-identified region in the second image may be selected, and then only the information in such region is identified. In this way, the calculation amount required for identification can be reduced, and the identification efficiency can be improved, because sometimes the user only needs the information in the partial region of the second image. In some embodiments, after the corresponding information in the second image is identified, the identified information is displayed, and then the user can select at least part of the identified information for inputting, for example, copying user name information in the identified information and pasting the user name information into the information input page. In this way, compared with direct input through the handle, the efficiency and convenience of information input can be improved.

In some embodiments, inputting the target information in the information input page based on the information in the second image includes: identifying the information in the second image; and inputting the identified information into the information input page as the target information. In this way, more intelligent input can be achieved by identifying the information in the second image and automatically and directly inputting the corresponding information. In addition, to reduce occurrence of information input errors, the user can check the input information with the information in the second image before confirming the input target information, and if there is an input error, the user can make a change.

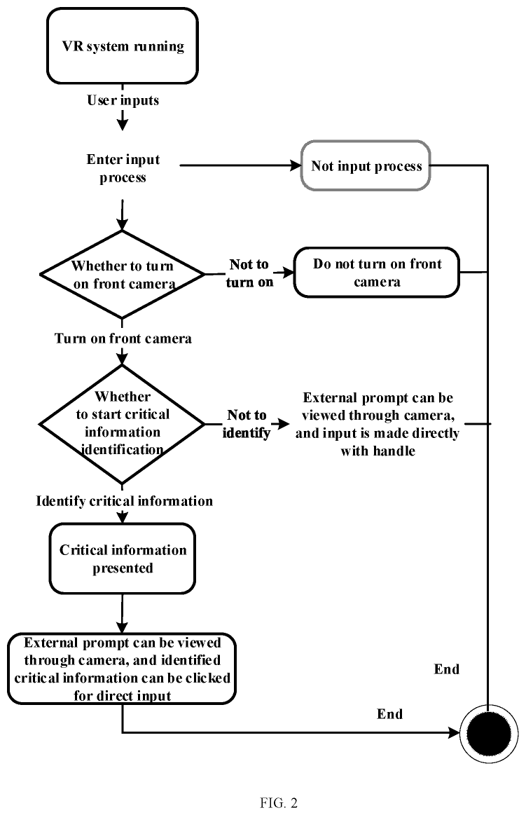

The following uses a VR head-mounted device as an example with reference to FIG. 2 for description to better understand the present disclosure. As shown in FIG. 2, during the operation of a VR system, a scenario where a user inputs information is often encountered. At this time, it may be determined whether to enter an information input process. If not, the process ends without further processing. If yes, it may be determined whether to turn on a camera (for example, a front camera). If the front camera is not to be turned on, the process ends without further processing. If it is determined to turn on the front camera, it may be further determined whether to start critical information identification. If the critical information identification is not to be started, the second image carrying the external prompt information may be obtained through the camera, and the target information is directly input by using the handle. If it is determined that the critical information identification is to be started, the critical information in the second image, for example, information in a partial region of the second image, may be identified. After that, the identified critical information may be displayed, that is, the critical information is presented. After the critical information is identified, at least part of the identified critical information may be selected, and then input into the information input page. It should be understood that the above steps are only exemplary, and the order of the steps may be changed, other steps may be added, or some steps may be omitted.

By adopting the information processing method of the present disclosure, the head-mounted device system can simultaneously display the first image and the second image, and can perform critical information identification, thereby greatly improving extraction of the external prompt information, improving the information input efficiency of the user, and enhancing the user experience. In addition, the user can view the first image displaying the internal information and the second image carrying the external prompt information without switching the image scene displayed in the screen interface.

An embodiment of the present disclosure further provides an information processing apparatus 400. The information processing apparatus 400 includes an input box display module 401, an image obtaining module 402, an image display module 403, and an information input module 404. In some embodiments, the input box display module 401 is configured to display an information input page in a first image displayed in a screen interface of a head-mounted device in response to a preset operation. In some embodiments, the image obtaining module 403 is configured to obtain a second image through a camera. In some embodiments, the image display module 404 is configured to display the second image in the screen interface. In some embodiments, the information input module 405 is configured to input target information in the information input page based on information in the second image.

It should be understood that the content described with respect to the information processing method is also applicable to the information processing apparatus 400 here, which is not described in detail here for the sake of simplicity.

In some embodiments, the information processing apparatus further includes a camera turn-on module, and the camera turn-on module is configured to determine whether to turn on the camera, where when it is determined to turn on the camera, the second image is obtained through the camera; and the camera turn-on module is further configured to perform no further processing when it is determined to not to turn on the camera. In some embodiments, the camera includes a front camera of the head-mounted device. In some embodiments, displaying the second image in the screen interface includes: superimposing and displaying the second image on the first image; or displaying the second image in a display region different from that of the first image in the screen interface. In some embodiments, when the second image is superimposed and displayed on the first image, the second image is superimposed and displayed on the first image in a transparent or semi-transparent manner. In some embodiments, inputting the target information in the information input page based on the information in the second image includes: directly inputting the target information in the information input page through a handle of the head-mounted device. In some embodiments, inputting the target information in the information input page based on the information in the second image includes: determining whether the information in the second image is identified; displaying the identified information when it is determined that the information in the second image is identified; and inputting at least part of the identified information in the information input page based on the identified information. In some embodiments, inputting the target information in the information input page based on the information in the second image includes: identifying the information in the second image; and inputting the identified information into the information input page as the target information.

In addition, the present disclosure further provides a terminal. The terminal includes: at least one memory and at least one processor, where the memory is configured to store program code, and the processor is configured to invoke the program code stored in the memory to perform the information processing method.

In addition, the present disclosure further provides a computer storage medium. The computer storage medium stores program code, and the program code is configured to perform the information processing method.

As described above, the information processing method and apparatus of the present disclosure are described based on the embodiments and application examples. In addition, the present disclosure further provides a terminal and a storage medium, which are described below.

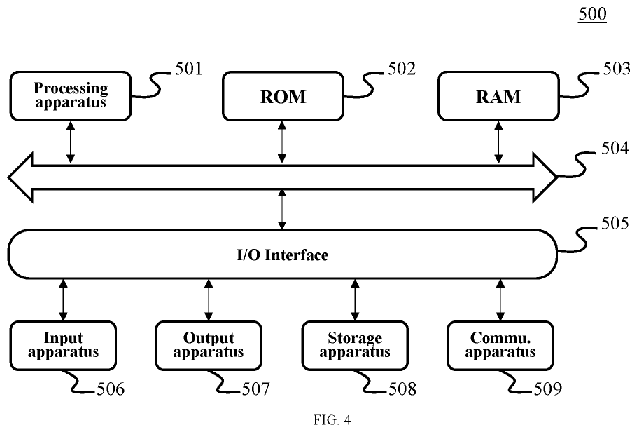

Reference is made to FIG. 4 below, which shows a schematic structural diagram of an electronic device (such as a terminal device or a server) 500 suitable for implementing embodiments of the present disclosure. The terminal device in this embodiment of the present disclosure may include, but is not limited to, a mobile terminal such as a mobile phone, a notebook computer, a digital broadcasting receiver, a personal digital assistant (PDA), a tablet computer, a portable multimedia player (PMP), and a vehicle-mounted terminal (such as a vehicle-mounted navigation terminal), and a fixed terminal such as a digital TV and a desktop computer. The electronic device shown in FIG. 4 is merely an example, and shall not impose any limitation to the function and usage scope of the embodiments of the present disclosure.

As shown in FIG. 4, the electronic device 500 may include a processing apparatus (such as a central processing unit and a graphics processor) 501. The processing apparatus 501 may perform various appropriate actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touch pad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a magnetic tape and a hard disk; and a communication apparatus (Commu. apparatus) 509. The communication apparatus 509 may allow the electronic device 500 to perform wireless or wired communication with other devices to exchange data. Although FIG. 4 shows the electronic device 500 having various apparatuses, it should be understood that not all of the illustrated apparatuses are necessarily implemented or included. Alternatively, more or fewer apparatuses may be implemented or provided.

Particularly, according to the embodiments of the present disclosure, the processes described above with reference to the flowcharts may be implemented as a computer program, and the computer program includes program code that, when executed by a processor, causes the methods shown in the flowcharts to be performed. For example, an embodiment of the present disclosure includes a computer program product, which includes a computer program carried on a computer-readable medium, and the computer program includes program code that, when executed by a processor, causes the methods shown in the flowcharts to be performed. In such embodiments, the computer program may be downloaded and installed from a network through the communication apparatus 509, or installed from the storage apparatus 508, or installed from the ROM 502. When the computer program is executed by the processing apparatus 501, the above steps defined in the method of the embodiment of the present disclosure are performed.

It should be noted that the above-mentioned computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program. The program may be used by or in conjunction with an instruction execution system, apparatus, or device. In the present disclosure, the computer-readable signal medium may include a data signal that propagates in a baseband or as a part of a carrier, and carries computer-readable program code. This propagated data signal may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program for use by or in conjunction with an instruction execution system, apparatus, or device. The program code contained in the computer-readable medium may be transmitted by any suitable medium, including but not limited to: an electric wire, an optical cable, a radio frequency (RF), or any suitable combination thereof.

In some implementations, a client and a server may communicate using any currently known or future developed network protocol such as a hypertext transfer protocol (HTTP), and may be interconnected with digital data communication (for example, a communication network) in any form or medium. Examples of the communication network include a local area network (“LAN”), a wide area network (“WAN”), an internet (for example, the Internet), and a peer-to-peer network (for example, an ad hoc peer-to-peer network), as well as any currently known or future developed network.

The above-mentioned computer-readable medium may be included in the above-mentioned electronic device, or may also exist alone without being assembled into the electronic device.

The above-mentioned computer-readable medium carries one or more programs, and when the above-mentioned one or more programs are executed by the electronic device, the electronic device is caused to execute the above-mentioned method of the present disclosure.

The computer program code for performing the operations of the present disclosure may be written in one or more programming languages or a combination thereof, where the above-mentioned programming languages include object-oriented programming languages such as Java, Smalltalk, C++, and also include conventional procedural programming languages such as “C” language or similar programming languages. The program code may be executed entirely on a user computer, partially on the user computer, as a stand-alone software package, partially on the user computer and partially on a remote computer, or entirely on the remote computer or server. In the scenario involving the remote computer, the remote computer may be connected to the user computer through any type of network, including a local area network (LAN) or a wide area network (WAN), or may be connected to an external computer (for example, connected via the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may occur out of the order noted in the drawings. For example, two blocks shown in succession may, in fact, be executed substantially concurrently, or the blocks may sometimes be executed in the reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments described in the present disclosure may be implemented by means of software or hardware. The name of a unit does not constitute a limitation of the unit itself under certain circumstances.

The functions described herein above may be performed, at least in part, by one or more hardware logic components. For example, without limitation, available exemplary state hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the foregoing. More specific examples of the machine-readable storage medium may include an electrical connection with one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, an information processing method is provided. The information processing method includes: displaying an information input page in a first image displayed in a screen interface of a head-mounted device in response to a preset operation; obtaining a second image through a camera; displaying the second image in the screen interface; and inputting target information in the information input page based on information in the second image.

According to one or more embodiments of the present disclosure, the information processing method further includes: determining whether to turn on the camera, where when it is determined to turn on the camera, the second image is obtained through the camera; and when it is determined to not turn on the camera, no further processing is performed.

According to one or more embodiments of the present disclosure, the camera includes a front camera of the head-mounted device.

According to one or more embodiments of the present disclosure, displaying the second image in the screen interface includes: superimposing and displaying the second image on the first image; or displaying the second image in a display region different from that of the first image in the screen interface.

According to one or more embodiments of the present disclosure, when the second image is superimposed and displayed on the first image, the second image is superimposed and displayed on the first image in a transparent or semi-transparent manner.

According to one or more embodiments of the present disclosure, inputting the target information in the information input page based on the information in the second image includes: directly inputting the target information in the information input page through a handle of the head-mounted device.

According to one or more embodiments of the present disclosure, inputting the target information in the information input page based on the information in the second image includes: determining whether the information in the second image is identified; displaying the identified information when it is determined that the information in the second image is identified; and inputting at least part of the identified information in the information input page based on the identified information.

According to one or more embodiments of the present disclosure, inputting the target information in the information input page based on the information in the second image includes: identifying the information in the second image; and inputting the identified information into the information input page as the target information.

According to one or more embodiments of the present disclosure, an information processing apparatus is further provided. The information processing apparatus includes: an input box display module configured to display an information input page in a first image displayed in a screen interface of a head-mounted device in response to a preset operation; an image obtaining module configured to obtain a second image through a camera; an image display module configured to display the second image in the screen interface; and an information input module configured to input target information in the information input page based on information in the second image.

According to one or more embodiments of the present disclosure, a terminal is provided. The terminal includes: at least one memory and at least one processor, where the at least one memory is configured to store program code, and the at least one processor is configured to invoke the program code stored in the at least one memory to perform the method according to any one of the above.

According to one or more embodiments of the present disclosure, a storage medium is provided. The storage medium is configured to store program code, and the program code is configured to perform the above-mentioned method.

The above description is merely preferred embodiments of the present disclosure and the explanation of the applied technical principles. Those skilled in the art should understand that the disclosure scope involved in the present disclosure is not limited to the technical solutions formed by the specific combination of the above-mentioned technical features, and should also cover other technical solutions formed by any combination of the above-mentioned technical features or their equivalent features without departing from the above-mentioned disclosure concept. For example, the technical solutions are formed by replacing the above-mentioned features with the technical features having similar functions disclosed in the present disclosure (but not limited to).

In addition, although various operations are depicted in a particular order, this should not be understood as requiring these operations to be performed in the specific order shown or in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments may also be implemented in combination in a single embodiment. Conversely, various features described in the context of a single embodiment may also be implemented in a plurality of embodiments individually or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely exemplary forms of implementing the claims.

1. An information processing method, comprising:
displaying an information input page in a first image displayed in a screen interface of a head-mounted device in response to a preset operation;
obtaining a second image through a camera;
displaying the second image in the screen interface; and
inputting target information in the information input page based on information in the second image.

2. The information processing method according to claim 1, further comprising: determining whether to turn on the camera,
wherein the second image is obtained through the camera in response to determining to turn on the camera.

3. The information processing method according to claim 1, wherein the camera comprises a front camera of the head-mounted device.

4. The information processing method according to claim 1, wherein displaying the second image in the screen interface comprises:
superimposing and displaying the second image on the first image; or
displaying the second image in a display region different from that of the first image in the screen interface.

5. The information processing method according to claim 4, wherein in response to superimposing and displaying the second image on the first image, the second image is superimposed and displayed on the first image in a transparent or semi-transparent manner.

6. The information processing method according to claim 1, wherein inputting the target information in the information input page based on the information in the second image comprises:
directly inputting the target information in the information input page through a handle of the head-mounted device.

7. The information processing method according to claim 1, wherein inputting the target information in the information input page based on the information in the second image comprises:
determining whether the information in the second image is identified;
displaying the identified information in response to determining that the information in the second image is identified; and
inputting at least part of the identified information in the information input page based on the identified information.

8. The information processing method according to claim 1, wherein inputting the target information in the information input page based on the information in the second image comprises:
identifying the information in the second image; and
inputting the identified information into the information input page as the target information.

9. (canceled)

10. A terminal, comprising:
at least one memory and at least one processor,
wherein the at least one memory is configured to store program code, and the at least one processor is configured to invoke the program code stored in the at least one memory to perform an information processing method comprising:
displaying an information input page in a first image displayed in a screen interface of a head-mounted device in response to a preset operation;
obtaining a second image through a camera;
displaying the second image in the screen interface; and
inputting target information in the information input page based on information in the second image.

11. A non-transitory storage medium, configured to store program code, wherein the program code is configured to perform an information processing method comprising:
displaying an information input page in a first image displayed in a screen interface of a head-mounted device in response to a preset operation;
obtaining a second image through a camera;
displaying the second image in the screen interface; and
inputting target information in the information input page based on information in the second image.

12. (canceled)

13. (canceled)

14. The terminal according to claim 10, wherein the method further comprises: determining whether to turn on the camera,
wherein the second image is obtained through the camera in response to determining to turn on the camera.

15. The terminal according to claim 10, wherein the camera comprises a front camera of the head-mounted device.

16. The terminal according to claim 10, wherein displaying the second image in the screen interface comprises:
superimposing and displaying the second image on the first image; or
displaying the second image in a display region different from that of the first image in the screen interface.

17. The terminal according to claim 16, wherein in response to superimposing and displaying the second image on the first image, the second image is superimposed and displayed on the first image in a transparent or semi-transparent manner.

18. The terminal according to claim 10, wherein inputting the target information in the information input page based on the information in the second image comprises:
directly inputting the target information in the information input page through a handle of the head-mounted device.

19. The terminal according to claim 10, wherein inputting the target information in the information input page based on the information in the second image comprises:
determining whether the information in the second image is identified;
displaying the identified information in response to determining that the information in the second image is identified; and
inputting at least part of the identified information in the information input page based on the identified information.

20. The terminal according to claim 10, wherein inputting the target information in the information input page based on the information in the second image comprises:
identifying the information in the second image; and
inputting the identified information into the information input page as the target information.

21. The non-transitory storage medium according to claim 11, the method further comprises: determining whether to turn on the camera,
wherein the second image is obtained through the camera in response to determining to turn on the camera.

22. The non-transitory storage medium according to claim 11, wherein the camera comprises a front camera of the head-mounted device.

23. The non-transitory storage medium according to claim 11, wherein displaying the second image in the screen interface comprises:
superimposing and displaying the second image on the first image; or
displaying the second image in a display region different from that of the first image in the screen interface.
